(19) United States
(12) Patent Application Publication
(10) Pub. No.: US 2016/0214836 A1
(43) Pub. Date: Jul. 28, 2016

(54) ELEVATOR CAR

(71) Applicant: KONE Corporation, Helsinki (FI)

(72) Inventor: Aki HAIKONEN, Hyvinkaa (FI)

(73) Assignee: KONE Corporation, Helsinki (FI)

(21) Appl. No.: 14/964,011

(22) Filed: Dec. 9, 2015

(30) Foreign Application Priority Data
Jan. 22, 2015 (EP) 15152191.1

(51) Int. Cl. B66B 13/16; B66B 13/08; B66B 13/22; B66B 9/00; B66B 5/02

(52) U.S. Cl. CPC B66B 13/165; B66B 9/00; B66B 5/02; B66B 13/22; B66B 13/08

(57) ABSTRACT

An elevator car has at least one centrally closing automatic elevator car door including at least one first door leaf supported on a door supporter via at least one first door hanger and at least one second door leaf supported on the door supporter via at least one second door hanger, which first and second door hangers are configured to be driven by a door drive in opposite directions; a door lock including a first lock part arranged at one of the door hangers and interacting with a second lock part of the door lock located at a fixed structure of the elevator car, whereby at least one of said lock parts is movable, and an electric lock indicator switch having a first switching element located at the second door hanger and a second switching element connected to a fixed structure of the elevator car, one of those switching elements being movable, which electric lock indicator switch has a lock indicating position when the movable switching element contacts the other one after the elevator car door is locked. The first lock part is located at the first door hanger, the movable switching element is configured to be moved only by the movable lock part moving into its locking position and only after the second door hanger has adopted its closed position, whereby in the final stage of the closing movement of the door hangers the movable lock part is configured to move into its locking position only after the first door hanger has adopted its closed position. Only one electric switch is necessary to confirm closing and locking of the door leaves of an automatic centrally opening elevator door.

The present invention relates to an elevator car having at least one centrally closing automatic elevator car door comprising at least one first door leaf supported on a door supporter via at least one first door hanger and at least one second door leaf supported on the door supporter via at least one second door hanger. The first and second door leaves are usually configured to be driven by a common door drive in opposite directions. On this behalf often an endless belt is driven by the door drive whereby the first door hanger is connected with a first part of the endless belt on one side between the door drive and the diverting pulley of the endless belt and the second door hanger is connected to the other part of the endless belt. Of course, also other per se known mechanisms are known to move the two door leaves in opposite directions during the opening and closing cycle of the elevator car door. The door leaves are usually mounted to door hangers which run in rails provided at the door supporter. The door supporter is usually a beam structure in the top of the elevator car usually having tracks on which the door hangers can slide. Usually, the door hangers are provided with rollers running in the tracks of the door supporter.

The elevator car door further comprises a door lock comprising a first lock part arranged on at least one of the both door hangers and interacting with a second lock part of the door lock located on a fixed structure of the elevator car, preferably at the door supporter. At least one of said lock parts is movable to perform a locking movement. Furthermore, the elevator car door comprises an electric lock indicator switch having a first switching element located at the second door hanger and a second switching element connected to a fixed structure of the elevator car, whereby one of those switching elements is movable. This lock indicator switch has a function to indicate the locking of the elevator car door which is essential for starting the movement of the elevator car which is to common regulations only allowed if the elevator car doors are closed and locked. Up to now the closing of the two door leaves of the centrally closing automatic elevator car door as well as the locking thereof is indicated by two separate electric contacts. This known solution is complicated as it necessitates the handling of two separate electric signals and the provision and installation of two electric switches.

An elevator car according to the preamble of claim 1 is known from JP 2011-173730 A.

It is therefore object of the present invention to provide an elevator car having a centrally closing automatic elevator car door which enables a simplified detection of the closing and locking of the elevator car door.

This object is solved in an elevator car of the above-mentioned type with the features of the characterizing part of claim 1. Preferred embodiments of the invention are subject-matter of the dependent claims. Some inventive embodiments are also discussed in the description as well as in the drawings of the present application. Likewise the different details presented in connection with each embodiment of the invention can also be applied in other embodiments.

According to the invention, the first lock part is located at the first door hanger and the movable switching element is configured to be moved into the lock indicating position of the electric lock indicator switch only by the movable lock part moving into its locking position. The movable switching element is further configured to be moved into its lock indicating position only after the second door hanger/leaf has assumed its closed position. Via this feature it is ensured that the switching of the electric lock indicator into the lock indicating position is only possible after the second hanger and correspondingly the second door leaf has adopted its closed position. On the other hand, in the final stage of the closing movement of the door leaves, the movable lock part is configured to move into its locking position only after the first door hanger has adopted its closed position. Via this feature it is ensured that also the first door hanger and correspondingly the first door leaf has obtained its closed position before the movable lock part is able to move into its locking position. As the movable switching element is only moved by the movable lock part into the lock indicating position of the electric lock indicator switch, it is therefore not sufficient that the second door leaf has adopted its closed position—which is the precondition that the electric lock indicator switch is able to obtain its lock indicating position—but as the movable switching element is only moved by the movable lock part into its connecting position with the other switching element it is also necessary that the first door leaf and the first door hanger have adopted their closed position. Therefore, the electric lock indicator switch only issues a lock indicating position signal after both door leaves are closed and the door lock is locked. This arrangement performs a kind of mechanically forced control of the door locking. As now the signal of the electric lock indicator switch ensures the closing as well as the locking of the elevator car door, one of the two electric switches which were used in prior art solutions until now may be omitted which essentially reduces the maintenance effort and reduces the electric installation amount. Therefore, the present invention provides a reliable and simple solution for ensuring the closing and locking of the elevator car door before the elevator car is able to move again.

As each door leaf is mounted via at least a corresponding first or second door hanger the closed position of the door leaf corresponds to a closed position of the door hanger. Hereinafter it is only referred to the closed position of the door hanger which includes of course the closed position of the corresponding door leaf. Of course the door hanger may also be integrated in the door leaf, in which case the features in the claims can directly been located on the door leaf instead on the hanger. Usually, each hanger is supported via rollers on corresponding tracks of the door supporter. This well known technology is not described or shown in the drawings for clarity reasons as the present invention only regards to the closing and locking of the car door.

In a preferred embodiment of the invention, the first switching element is the movable switching element, particularly a pivoted switching lever arm, and the second switching element is a fixed switching element, particularly a switching contact. In this case, the movable switching element is located at the second door hanger and can be easily operated by the movable lock part when the door leaves approach closed position, particularly if the movable lock part is located on the first door hanger.

Preferably, the first lock part is the movable lock part, particularly a lock latch and the second lock part is a fixed lock part, particularly a lock notch or a lock bolt. In this case, the movable lock part, preferably the lock latch, can easily engage with the movable switching element which is provided preferably at the second door hanger during the closing movement of the door leaves. This solution is easily to install and reduces the number of movable components mounted at the door supporter.

Preferably, the movable lock part, particularly the lock latch, has a control surface which is configured to push the movable switching element into the lock indicating position of the electric lock indicator switch. The switching movement of the movable switching element is therefore a mechanically forced movement caused by the movable lock part. This principle enables the issuing of the lock indicating signal based on three different requirements, the first one is the closing of the first door leaf/hanger, the second one is the closing of the second door leaf/hanger and the third one is the movement of the movable lock part into its locking position. The provision of a control surface on the lock latch allows a defined control of the movement of the movable switching element as desired.

In a preferred embodiment of the invention, the movable lock part, particularly lock latch, has a sliding ramp co-acting with the lock part connected to a fixed structure of the elevator car, preferably a lock bolt, when the first door hanger approaches the closed position, whereby the engagement of the sliding ramp with the lock bolt moves the lock latch out of its locking position and into a switching position in which the lock latch is able to move the movable switching element. The sliding ramp ends when the first door hanger has achieved its closed position enabling the lock latch to move into its locking position. The sliding ramp therefore enables the lock latch to get into a position to grip the movable switching element for the final switching movement and ensures on the other hand that the movement of the lock latch into the locking position is only able after the first hanger has achieved its closed position.

In a preferred embodiment of the invention, the movable lock part is biased into its locking position, at least when approaching or reaching the closed position of the door hanger and door leaf. Such a biasing can for example be realized by a spring means but is realized in a simple and reliable embodiment by gravity. Accordingly, the lock latch can for example be realized as a pivoted lever whereby one part of the lever has a larger mass than the other one in which case the lock latch will always turn in a way that the lever part with the higher mass is drawn downwards. By this means, the lock latch could constantly be biased into its locking position. This solution is very reliable as for example spring means can break and lose its function whereas a gravity induced by biasing can only lose functionality if the door lock is worn as to block the movement of the movable lock part in general.

Of course, the movable lock part is preferably connected with an actuator, e.g. solenoid to move it out of its locking position to enable the opening of the car door.

Of course, each door leaf is connected with the corresponding door hanger via common connecting means, e.g. bolts etc.

Preferably, the first lock part, preferably lock latch, has a first lock detent engaging with the second lock part, preferably lock bolt, in the closed position of the first door hanger and door leaf. This ensured secure locking of the first door hanger. Via this purely mechanically controlled movement it is properly ensured that locking is only possible with closed position of the first door hanger.

In this solution, preferably the first lock detent, the control surface and the sliding ramp are located at a protrusion of the movable lock part which further comprises the lock detent. Therefore, all essential control surfaces of the movable lock part are located on one protrusion which co-acts with the lock part connected to the fixed car structure, preferably door supporter.

Preferably, the first switching element is the movable switching element and located at the second hanger in a position to be moved in lock indicating position by the movable lock part only after the second door hanger has reached its closed position. This ensures that the switching of the electric lock indicator switch is only possible after the second door hanger have reached its closed position.

Preferably, the first lock part is a lock latch which is preferably pivotally hinged at the first door hanger. Such a lock latch has an easy movement pattern and can easily be embodied as to be biased into a preferred moving direction by the lever ratio of the parts of the pivotally hinged lock latch.

Preferably, the first switching element comprises a switching lever arm which is pivoted at the second door hanger. Such an arrangement allows an easy engagement of the switching lever arm with the movable lock part on the first door hanger.

Although the components connected to a fixed structure of the elevator car, particularly the second lock part of the door lock and the second switching element can be connected to any structural part of the car structure, for example the car frame, it is preferable to use the door supporter as the fixed structure of the elevator car because in this case all door related functions of door closing and locking are provided in connection with the door supporter. This includes the arrangement of all lock parts and electric lock indicator parts which are not located on the door hangers.

Of course, the invention also refers to an elevator comprising an elevator car according to one of the preceding claims running in an elevator shaft and driven by a drive unit acting on suspension ropes on which the elevator car is suspended. The drive unit of the elevator is thereby configured to be operated only after the electric lock indicator switch issues a lock indicating signal after having adopted its lock indicating position.

In a preferred embodiment of the invention the movable switching element is integrated with the movable lock part so that only one movable element is necessary for the complete closing and locking arrangement as the movable locking part and movable switching element which are usually arranged on different movable components are now both arranged at one common movable part.

It is clear for the skilled person that the above-mentioned embodiments can be combined with each other arbitrarily unless technical features contradict each other.

The invention is now described schematically in connection with the enclosed drawings. In these drawings

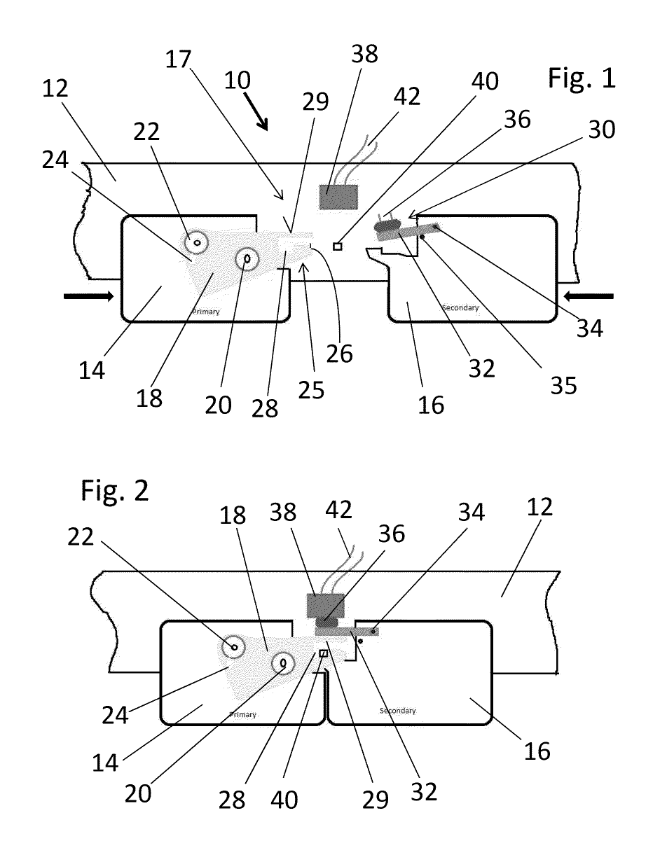

FIG. 1 shows a side view of a first embodiment of two door hangers running at a door supporter when approaching the closed position,

FIG. 2 the side view of the embodiment of FIG. 1 after the door hangers have adopted their closed position and the elevator car door is locked,

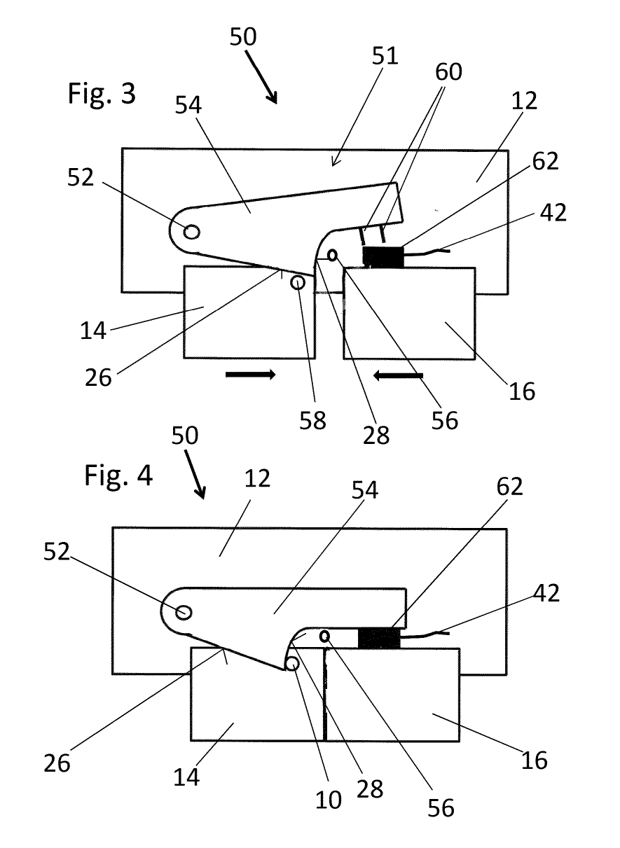

FIG. 3 a side view according to FIG. 2 of a second embodiment of the invention with two door hangers approaching closed position,

FIG. 4 a side view of the second embodiment according to FIG. 3 after the door hangers have adopted their closed position and the car door is locked, and

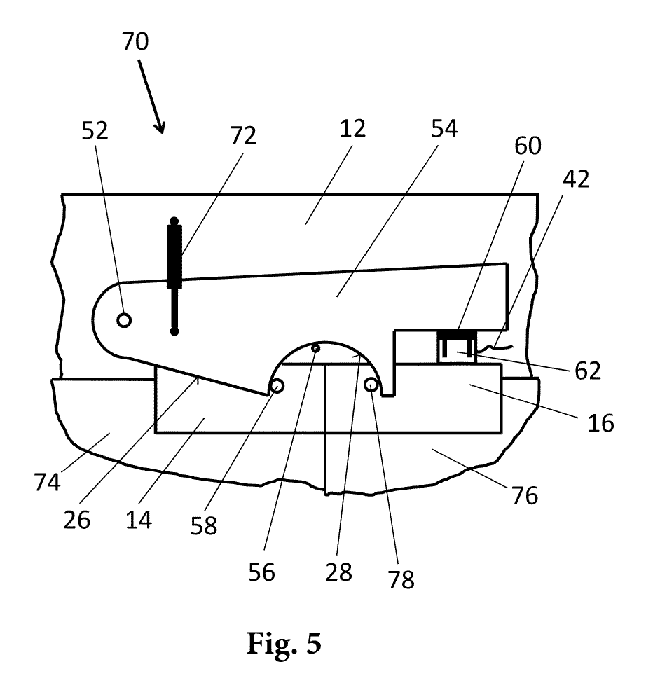

FIG. 5 a side view of a third embodiment similar to FIGS. 3 and 4 in closed position with an additional mechanical locking of the second door hanger.

FIG. 1 shows an arrangement 10 of a door supporting and closing/locking mechanism in the upper part of a centrally closing automatic elevator car door comprising a door supporter 12 on which a first door hanger 14 and a second door hanger 16 are horizontally movable by a door drive (not shown) in horizontal direction and in mutually opposite directions as shown by the arrows. Typically, the door hangers have rollers which run in at least one track of the door supporter. The first door hanger 14 has a door latch 18 as first part of a door lock 17, which lock latch 18 is pivotally hinged at a pivot axis 20 on the first door hanger 14 whereby the extent of the possible pivot movement of the lock latch 18 is controlled via a control pin 22 on the first door hanger 14 in connection with a long hole 24 in the lock latch 18. The lock latch 18 has in the direction facing the second door hanger 16 a protrusion 25 having a sliding ramp 26 and a lock detent 28 behind the sliding ramp 26. Furthermore, the lock latch 18 has in the direction facing the second door hanger 16 and above the protrusion 25 a control surface 30 which is configured to co-act with a switching lever arm 32 of a first switching element 30 located on the second door hanger 16, which switching lever arm 32 is pivoted on a second pivot axis 34 arranged on the second door hanger 16 and rests on a stopper 35. The switching lever arm 32 carries at is end a contact bridge 36 co-acting with a second switching element 38 located on the door supporter 12 whereby the contact bridge 36 of the switching lever arm 32 of the first switching element 30 is able to engage complementary electric contacts of the second switching element 38 after the second door hanger 16 has adopted its closed position. The door supporter 12 carries furthermore a lock bolt 40 as the second part of the door lock 17 whose first part is formed by the lock latch 18. These two lock parts 18, 40 co-act together to lock the closed positions of the door hangers 14, 16 as it will be shown in connection with FIG. 2.

FIG. 2 shows the arrangement of FIG. 1 in a closed and locked position of the door hangers and the corresponding door leaves.

The function of this first embodiment of the invention corresponding to FIGS. 1 and 2 is described as follows. When the first and second door hangers 14, 16 approach closed position as it is shown in FIG. 1, the sliding ramp 26 engages the lock bolt 40 which pushes protrusion 25 of the lock latch 18 down so that the control surface 30 of the lock latch 18 gets under the switching lever arm 32 of the first switching element 30 of the approaching second door hanger 16. In the closed position of both door hangers which is shown in FIG. 2, the lock bolt 40 gets into the lock detent 28 on the protrusion 25 of the lock latch 18 which is located behind the sliding ramp 26 so that the protrusion 25 and accordingly the control surface 30 of the lock latch is able to move upwards into the locking position of the lock latch 18 whereby the lock detent 28 engages with the lock bolt 40. During this locking movement of the lock latch 18 the contact bridge 36 on the switching lever arm 32 is pushed by the control surface 30 of the lock latch 18 into the complementary electric contacts of the second switching element 38 located at the door supporter 12. This is only possible after the second door hanger has also reached its closed position, wherein the contact bridge 36 on the second lever arm is in alignment with the complementary contacts of the switching element 38. On the other hand the pushing of the switching lever arm 32 by the control surface 30 of the lock latch 18 ensures that also the first door hanger 14 has achieved its closed position because the movement of the lock latch 18—which is controlled via the sliding surface 26 and the lock detent 28 in connection with the lock bolt 40—into its locking position is only possible after also the first door hanger 14 has achieved its closed position so that the protrusion 25 of the lock latch 18 can move upwards in locking position, thereby pressing the contact bridge 36 on the switching lever arm 32 into the electric contacts of the second switching element 38 so that the electric lock indicator switch 30, 38 issues a lock indicating signal via signal cables 42.

FIGS. 3 and 4 show a second embodiment of the invention whereby identical or functional identical parts in the different drawings have the same reference numbers. In this second embodiment 50 of an elevator car door closing and locking arrangement, a door supporter 12 carries a first pivot axis 52 on which a lock latch 54 is pivotally hinged. The lock latch 54 rests on a stopper 56 when the two door hangers 14, 16 are not in the central area of the door supporter during the final stage of their closing movement. The movable lock latch 54 forms the second lock part of a door lock 51 whose first part is formed by a lock bolt 58 provided on the first door hanger 14. The lock latch 54 carries a contact bridge 60 as second switching element of an electric lock indicator switch whose first switching element is formed by electric contacts 62 located at the second door hanger 16. The electric contacts 62 of the first switching element are connected to signal cables 42 to issue a lock indicating signal to the elevator control. The essential idea of this embodiment is therefore to integrate the movable lock part 54 with the movable switching element 60, reducing the number of moving components in the arrangement.

Also the first switching element 62 on the second door hanger can be embodied as contact bridge, in which case the signal cables 42 can be provided in connection with the electric contacts of the second switching element 60 located on the door supporter 12, which is easier to handle. The engagement of the contact bridge 60 of the lock latch 54 in the electric contacts of the first switching element 62 is only possible after the second door hanger 16 has adopted its closed position. The lock latch 54 has a sliding ramp 25 and a lock detent 28 which engage with the bolt lock 58 located at the first door hanger 14. Via this engagement, the lock latch 54 is pushed upwards during the final stage of the closing movement of the door leaves so that the second switching element 60 moves above the first switching element 62. When the door hangers 14, 16 achieve their closed position, the lock bolt 58 gets into the lock detent 28 of the lock latch 54, whereby the lock latch 54 move down by gravity whereby the contacts of the second switching element 60 moves into the electric contacts of the first switching element 62. Via this means, the locking indication signal is only issued by the electric lock indicator switch 60, 62 after both door hangers 14, 16 have adopted their closed position and after the lock latch 54 has moved down into locking position whereby the locking detent 28 on the lock latch 54 blocks the lock bolt 58 on the first door hanger 14 so that the first door hanger cannot move into opening direction while the movement of the second door hanger 16 is blocked by the interaction of the first switching and second elements 62, 60. Therefore, with one electric switch 60, 62, the correct closing of both door hangers 14, 16 of the centrally opening elevator car door as well as the locking thereof is confirmed.

FIG. 5 shows a third embodiment very similar to the second embodiment, whereby identical or functionally identical parts carry the same reference number.

Additionally to FIGS. 3 and 4, the arrangement 70 of a closing and locking arrangement of a centrally opening elevator car door has an actuator 72 between the door supporter 12 and the lock latch 54 for moving the lock latch 54 in opening position when the car doors shall be opened. This actuator can also be provided in the other embodiments.

Further the lock detent 28 of the lock latch 54 is semi-circular as to co-act with the lock bolt 58 on the first door hanger as well as with a second lock bolt 78 on the second door hanger 16. The lock latch 54 therefore mechanically locks both door hangers 14, 16 via the interaction of the lock detent 28 with the lock bolts 58, 78 provided on both door hangers 14, 16. FIG. 5 also shows the first and second door leaves 74, 76 connected to their corresponding first and second door hangers 14, 16.

Also in this embodiment the signal cables 42 can advantageously be located in connection with the second switching element 60 located at the door supporter 12.

The invention is not restricted to the enclosed embodiments but may be varied within the scope of the appended patent claims.

Preferably, a drive is provided to move the movable lock part, particularly lock latch 18, 54, out of its locking position shown in FIGS. 2, 4. The drive can for example be embodied as it is shown in FIG. 5.

1. an elevator car having at least one centrally closing automatic elevator car door comprising:
at least one first door leaf supported on a door supporter via at least one first door hanger and at least one second door leaf supported on the door supporter via at least one second door hanger, which first and second door hangers are configured to be driven by a door drive in opposite directions;
a door lock comprising a first lock part arranged at one of the door hangers and interacting with a second lock part of the door lock located at a fixed structure of the elevator car, whereby at least one of said lock parts is movable, and
an electric lock indicator switch having a first switching element located at the second door hanger and a second switching element connected to a fixed structure of the elevator car, one of those switching elements being movable, which electric lock indicator switch has a lock indicating position when the movable switching element contacts the other one after the elevator car door is locked,
wherein the first lock part is located at the first door hanger, that the movable switching element is configured to be moved only by the movable lock part moving into its locking position and only after the second door hanger has adopted its closed position, whereby in the final stage of the closing movement of the door hangers the movable lock part is configured to move into its locking position only after the first door hanger has adopted its closed position.

2. The elevator car according to claim 1, wherein the first switching element is the movable switching element, and the second switching element is the switching element connected to the fixed structure of the elevator car.

3. The elevator car according to claim 1, wherein the first lock part is the movable lock part, and the second lock part is the lock part connected to a fixed structure of the elevator car.

4. The elevator car according to claim 3, wherein the movable lock latch has a control surface which is configured to push the movable switching element into the lock indicating position of the electric lock indicator switch.

5. The elevator car according to claim 4, wherein the movable lock latch has a sliding ramp co-acting with the lock bolt when the first door hanger approaches its closed position, whereby the engagement of the sliding ramp with the lock bolt moves the lock latch out of its locking position and into a switching position in which the lock latch can move the movable switching element, which sliding ramp ends in a lock detent when the first door hanger has achieved its closed position, enabling the lock latch to move into its locking position.

6. The elevator car according to claim 1, wherein the movable lock part is biased into its locking position, at least when the first door hanger approaches or reaches its closed position.

7. The elevator car according to claim 6, wherein the movable lock part is biased by gravity into its locking position.

8. The elevator car according to claim 1, wherein the movable lock part has a first lock detent, engaging with the second lock part in the closed position of the first door hanger.

9. The elevator car according to claims 4, wherein the control surface and the sliding ramp are located at a protrusion of the lock latch which further comprises the lock detent.

10. The elevator car according to claim 1, wherein the first switching element is located as to enable movement of the electric lock indicator switch into its lock indicating position by the movable lock part only after the second door hanger has reached its closed position.

11. The elevator car according to claim 1, wherein the first lock part is a lock latch pivotally hinged at the first door hanger.

12. The elevator car according to claim 1, wherein the first switching element comprises a switching lever arm pivoted at the second door hanger.

13. The elevator car according to claim 1, wherein the fixed structure of the elevator car is the door supporter.

14. The elevator car according to claim 1, wherein the door hangers are integrated with the corresponding door leaves.

15. An elevator comprising:
the elevator car according to claim 1, running in an elevator shaft driven by a drive unit acting on suspension ropes on which the elevator car is suspended,
whereby the drive unit is configured to be operated only if the electric lock indicator switch issues a lock indicating signal.

16. The elevator car according to claim 1, wherein the first switching element is the movable switching element, comprising a pivoted switching lever arm, and the second switching element is the switching element connected to the fixed structure of the elevator car, comprising a switching contact.

17. The elevator car according to claim 1, wherein the first lock part is the movable lock part, comprising a lock latch and the second lock part is the lock part connected to a fixed structure of the elevator car, comprising a lock notch or a bolt.

18. The elevator car according to claim 2, wherein the first lock part is the movable lock part, and the second lock part is the lock part connected to a fixed structure of the elevator car.

19. The elevator car according to claim 2, wherein the movable lock part is biased into its locking position, at least when the first door hanger approaches or reaches its closed position.

20. The elevator car according to claim 3, wherein the movable lock part is biased into its locking position, at least when the first door hanger approaches or reaches its closed position.
